(19) United States
(12) Patent Application Publication
(10) Pub. No.: US 2024/0378087 A1
(43) Pub. Date: Nov. 14, 2024

(54) On-Demand Intercloud Data Storage Transfer

(71) Applicant: Google LLC, Mountain View, CA (US)

(72) Inventors: Anup Talwalkar, Seattle, WA (US); Sowmya Dayanand, Redmond, WA (US); Joseph Cox, Seattle, WA (US); Ajitesh Abhishek, Mountain View, CA (US)

(21) Appl. No.: 18/196,025

(22) Filed: May 11, 2023

(51) Int. Cl. G06F 9/50

(52) U.S. Cl. CPC G06F 9/5038; G06F 9/5072

(57) ABSTRACT

A system and method for on-demand event-driven data transfer in which a serverless listener detects a transfer request from a location remote from the data transfer system, the transfer request specifying one or more data objects, a source location of the one or more data objects, and a destination location to which the one or more data objects are to be transferred, stores the transfer request in the memory, and notifies a data transfer service included in the data transfer system of the transfer request. The data transfer service is configured to control one or more worker nodes for migration of data, whereby execution of the transfer request causes the one or more worker nodes to move the one or more data objects specified in the transfer request from the source location to the destination location.

### BACKGROUND

Cloud storage is a mode of data storage in which data objects are stored in one or more storage devices that are maintained by a third-party provider. The stored data may be accessed or controlled remotely over a network connection through instructions from one or more devices that are capable of accessing or controlling the stored data.

In some cases, data may be stored at a storage location of one cloud platform but be needed for processing at a storage location of a different cloud platform. The cloud platforms may be managed by the same or a different third-party provider. In such a case, management of the stored data may involve migrating data objects between the two cloud platforms.

Data migration between different cloud platforms can be a time-consuming process. Typically, a source cloud platform is scanned for data to be migrated, and any data identified in the scan is batched together and transferred to a destination cloud platform. However, such scans are often limited to a preset frequency, such as once every hour. This means there may be long wait times for backup operations and synchronization between platforms. Additionally, because entire databases may be scanned and several data objects may be batched before migration, the transfer process can be subject to higher latency compared to a transfer of an individual data object or even a small group of data objects

### BRIEF SUMMARY

The present disclosure describes event-driven and on-demand techniques for data migration between cloud platforms. The techniques reduce the amount of time required to complete a data transfer request by handling the request as it arrives. This is accomplished by listening for the requests, immediately setting up a transfer event for each received request, and immediately forwarding each transfer event for execution.

One aspect of the disclosure is directed to a data transfer system comprising: one or more processors; and memory having programmed thereon instruction for causing the one or more processors to: detect a transfer request transmitted from a location remote from the data transfer system, wherein the transfer request specifies one or more data objects, a source location of the one or more data objects, and a destination location to which the one or more data objects are to be transferred; in response to detection of the transfer request; create a transfer event for the one or more data objects; and notify a data transfer service included in the data transfer system of the transfer event, wherein the data transfer service is configured to control one or more worker nodes for migration of data, whereby execution of the transfer event causes the one or more worker nodes to move the one or more data objects specified in the transfer event from the source location to the destination location.

In some examples, each of the source location and the destination location may be located in different cloud platforms.

In some examples, the memory may further include a queue configured to store the transfer request, and each transfer request stored in the queue may correspond to a separate transfer event.

In some examples, the one or more processors may be configured to detect the transfer request stored in the queue using a serverless listener.

In some examples, the queue may be managed by a message queuing service, and the serverless listener may be configured to periodically check the message queuing service for new transfer requests on an order of minutes or faster.

In some examples, the serverless listener may be configured to identify the new transfer requests based on a message in the message queuing service requesting to initiate copying of a data object from a preconfigured transferred job associated with data transfer service.

In some examples, the memory may further include an application storage layer memory of the data transfer service configured to store the transfer event.

In some examples, the one or more processors may be configured to direct the transfer request to the memory using a serverless listener, and the transfer request may be directed to the memory in response to the transfer request being sent to an address of the serverless listener.

In some examples, the system may further include the data transfer service, and the data transfer service may be configured to: receive the transfer event from the memory; in response to the notification received from the one or more processors, select at least one of the one or more worker nodes for execution of the transfer event; and forward the transfer event to the selected worker nodes for execution.

In some examples, the data transfer service may be configured to: determine whether the transfer event is an object-level transfer event; in response to the transfer event being an object-level transfer event, forward the transfer event to the selected worker nodes for execution; and in response to the transfer event not being an object-level transfer event, hold the transfer event for batch migration.

In some examples, the system may further include the one or more worker nodes.

In some examples, the transfer request may be a request to replicate the one or more data objects in a plurality of destination locations, the data transfer service may be configured to assign the transfer event to a plurality of worker nodes, and each worker node may be assigned to copy the one or more data objects to a respective one of the plurality of destination locations.

Another aspect of the disclosure is directed to a method including: detecting, by one or more processors, a transfer request specifying one or more data objects, a source location of the one or more data objects, and a destination location to which the one or more data objects are to be transferred; creating, by the one or more processors, a transfer event for the one or more data objects; notifying, by the one or more processors, a data transfer service included in the data transfer system of the transfer event; controlling, by the data transfer service, one or more worker nodes for execution of the transfer event, whereby execution of the transfer event causes the one or more worker nodes to move the one or more data objects specified in the transfer request from the source location to the destination location.

In some examples, each of the source location and the destination location may be located in different cloud platforms.

In some examples, detecting the transfer request may involve periodically checking, by the one or more processors, a message queuing service for new transfer requests on an order of minutes or faster.

In some examples, the method may further include identifying, by the one or more processors, the new transfer requests based on a message in the message queuing service requesting to initiate copying of a data object from a preconfigured transferred job associated with the data transfer service.

In some examples, the method may further include storing, by the one or more processors, the transfer event in an application storage layer memory of the data transfer service, wherein the storing is performed by a serverless listener in response to the transfer request being sent to an address of the serverless listener.

In some examples, the method may further include, in response to the received notification: selecting, by the data transfer service, one or more worker nodes for execution of the transfer event; and forwarding, by the data transfer service, the transfer event to the one or more selected worker nodes for execution.

In some examples, the method may further include: determining, by the one or more processors, whether the transfer event is an object-level transfer event; in response to the transfer event being an object-level transfer event, forwarding, by the data transfer service, the transfer event to the selected worker nodes for execution.

In some examples, the transfer request may be a request to replicate the one or more data objects in a plurality of destination locations, the method may further include assigning, by the data transfer service, the transfer request to a plurality of worker nodes, and each worker node may be assigned to copy the one or more data objects to a respective one of the plurality of destination locations.

### BRIEF DESCRIPTION OF THE DRAWINGS

FIG. 1 is a block diagram of a system in accordance with an aspect of the disclosure.

FIGS. 2 and 3 are block diagrams of example data transfer systems included in the system of FIG. 1.

FIG. 4 is a flow diagram of an example routine for data transfer in accordance with an aspect of the disclosure.

### DETAILED DESCRIPTION

### Overview

The present disclosure provides a technique for on-demand transfer of one or more data objects that utilizes the underlying data migration architecture for transferring data between cloud platforms but bypasses the long waits caused by scanning and batching at predetermined times. This is accomplished by modifying the data migration protocol to continuously listen to a source queue for transfer requests, generate a transfer event in response to a detected transfer request, and forward the generated transfer event to one or more worker nodes for execution.

A system for executing the on-demand transfer technique may include an event queue to which transfer requests may be transmitted, one or more processors configured to receive notifications of transfer requests from the event queue, and one or more worker nodes configured to receive the transfer requests from the one or more processors and transfer the data objects from their source location to a specified destination location. The source and destination locations may be specified within the transfer request.

The systems and techniques disclosed herein have several advantages over conventional scanning-and-batching transfer protocols. In this regard, the systems and techniques described herein are constantly operating and have low downtime, thereby providing a fast and reliable way to backup data. Additionally, the number of worker nodes to which a transfer event can be sent is easily scalable. As such, data can be replicated to any desired number of destinations in short order by worker nodes operating in parallel. Furthermore, because the event queue is constantly listening for transfer requests, and the requests are immediately processed and forwarded to the worker nodes for execution, the system effectively provides for on-demand transfer of individual data objects.

### Example Systems

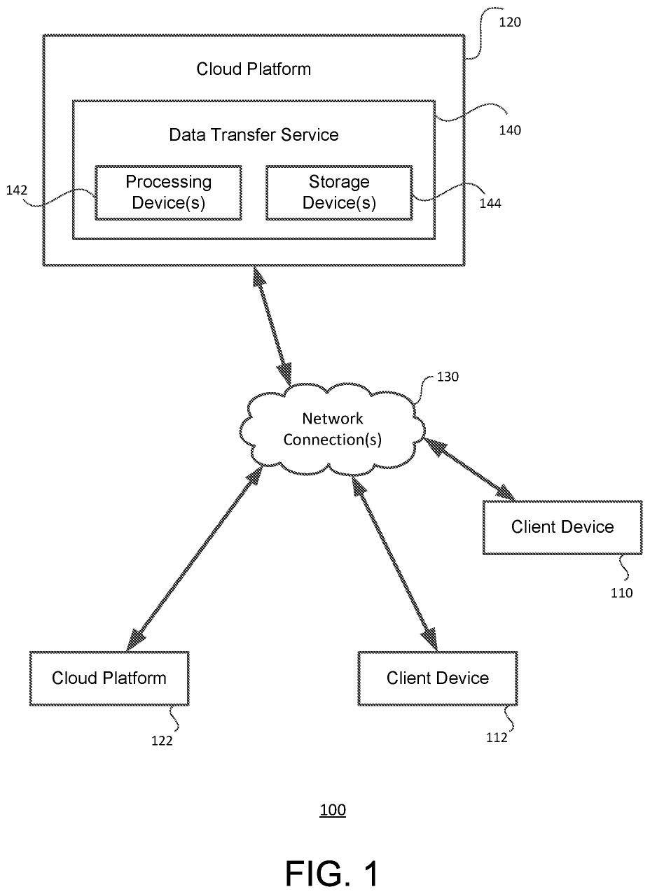

FIG. 1 is a block diagram of an example communications network 100. In the example of FIG. 1, the network 100 includes one or more client devices 110, 112 that may be operated by respective clients or users, one or more cloud platforms 120, 122 that may be operated by one or more different third-party providers, and one or more network connections 130 for connecting the client devices and cloud platforms with one another. The network connections 130 may include any one or combination of public network connections and private network connections such as a virtual private network (VPN) connection. Network connections may include various configurations and protocols including the Internet, World Wide Web, intranets, virtual private networks, wide area networks, local networks, private networks using communication protocols proprietary to one or more companies, Ethernet, WiFi (e.g., 702.71, 702.71b, g, n, or other such standards), and RPC, HTTP, and various combinations of the foregoing.

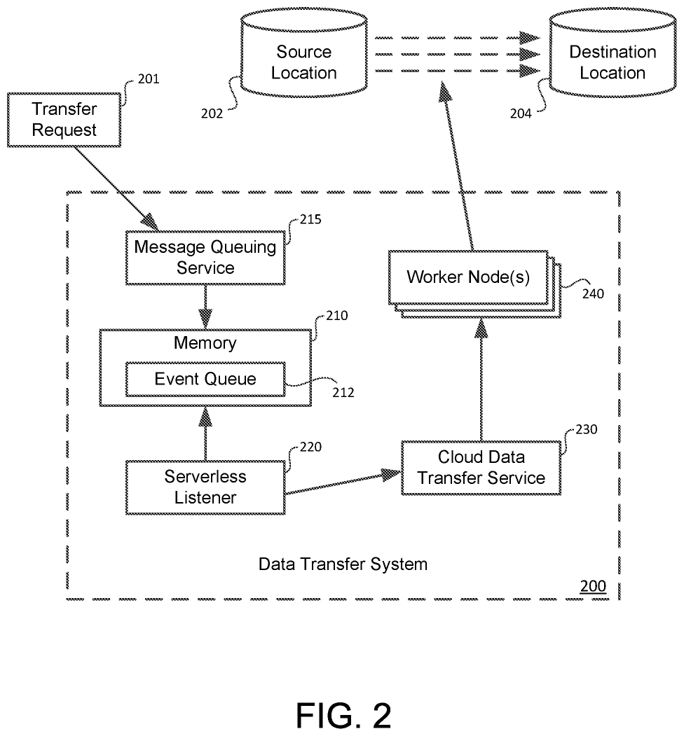

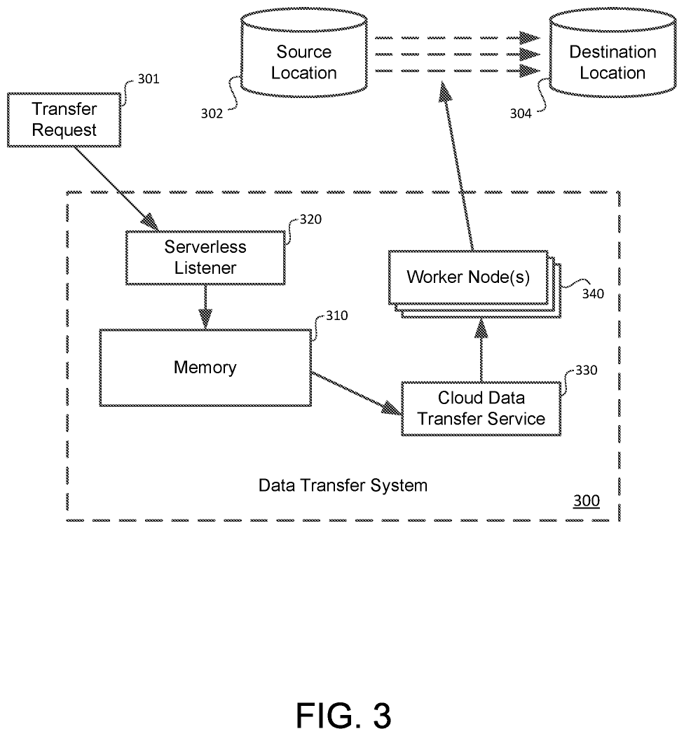

Each cloud platform 120 of the network 100 may include one or more datacenters, each datacenter including a plurality of servers capable of receiving, storing, processing, and transmitting data over the network. Data communicated over the network may originate from client devices or within the datacenters, and may be transferred between client devices and datacenters, in either direction. In some instances, data may be transferred between two datacenters of the same cloud platform or between datacenters of different cloud platforms. In order to facilitate transfer of data within and between the cloud platforms, each cloud platform 120 may include a data transfer service 140 for facilitating the transfer of data. The data transfer service 140 may include a combination of one or more processing devices 142 and one or more storage devices 144 for facilitating data transfers. Example implementations of the data processing and data storage components of the data transfer service 140 are described in greater detail herein, such as in the descriptions of FIGS. 2 and 3.

The processing devices 142 may include one or more computing devices, such as processors, servers, shards, cells, or the like. It should be understood that each datacenter of the network 100 may include any number of computing devices, that the number of computing devices in one datacenter may differ from a number of computing devices in another datacenter, and that the number of computing devices in a given datacenter may vary over time, for example, as hardware is removed, replaced, upgraded, or expanded. The processing devices 142 may be utilized as computing resources for workloads received from the client devices 110, such as a computing task offloaded by a client to be carried out by one or more remote servers.

The storage devices 144 may include one or more forms of memory, such as hard drives, random access memory, disks, disk arrays, tape drives, or any other types of storage devices. Each datacenter may implement any of a number of architectures and technologies, including, but not limited to, direct attached storage (DAS), network attached storage (NAS), storage area networks (SANs), fiber channel (FC), fiber channel over Ethernet (FCOE), mixed architecture networks, or the like. Additionally, the network 100 may include a number of other devices in addition to the processing devices and storage devices, such as communication devices to enable input and output between the processing devices of the same datacenter or different datacenters, between processing devices of different cloud platforms connected to the same network, and between components of the datacenters and cloud platforms and client devices. Such communication devices may include cabling, routers, connectors, and so on.

In some examples, the processing devices 142 and memory devices 144 may be configured to operate as virtual machines, whereby a given workload may be divided among the virtual machines included in one or more locations of a distributed network. The virtual machines may cumulatively provide an amount of processing power, such as an amount of processors or cores, as well as an amount of random access memory for completing various tasks or workloads that are provided to the distributed network.

FIG. 2 is a block diagram illustrating an example data transfer system 200 within a cloud platform, such as the cloud platform 120 of FIG. 1. The data transfer system 200 may include, but is not limited to, various components of the cloud platform such as the data transfer service 140 shown in FIG. 1. The data transfer system 200 is capable of handling transfer requests 201 on an on-demand basis. Each transfer request may specify a source location 202 at which the data to be transferred is originally stored and a destination location 204 to which the data is requested to be transferred. The source locations may further indicate the specific data to be transferred. Additionally or alternatively, the transfer request may identify the data to be transferred by a different identifier, such as a file name, prefix, or more general filter setting such as date range or data type. Transfer requests 201 may originate from any location, such as client devices connected to the data transfer system 200 or devices of other cloud platforms. Additionally or alternatively, transfer requests 201 may originate from the source location 202, the destination location 204, or a different location that is different from both the source location 202 and destination location 204.

The data transfer system 200 includes memory 210 for storing inbound transfer requests 201, one or more serverless listeners 220 to detect the inbound transfer requests 201, a cloud data transfer service 230 configured to manage the transfer of the requested data, and one or more workers 240 managed by the cloud data transfer service to execute the transfer.

In the example of FIG. 2, the memory 210 may include an event queue 212 managed by a message queuing service 215. Transfer requests 201 may be received by the message queuing service and temporarily stored at the event queue 212. The transfer request may be stored in an order based on the time that each of the transfer requests 201 are received, such as oldest to newest or vice versa. Each transfer request 201 stored in the event queue 212 may correspond to a different transfer event that can be handled separately by the data transfer service. In this manner, the transfer events can be handled by the system on an event-by-event basis, as opposed to batching a number of transfer requests into a larger, batched transfer event.

The serverless listener 220 may be configured to periodically check the message queuing service 215 to determine whether new transfer requests 201 have been stored at the event queue 212. Periodically checking the message queuing service 215 may occur on the order of minutes or seconds, such as every minute or every few minutes or another regular interval of time. The regular interval of time may be shorter than the interval over which transfer requests are typically batched and executed. For instance, in a system that typically batches and executes transfer requests hourly, the regular interval of time may be less than one hour.

If any transfer requests 201 are present in the queue 212, then the serverless listener 220 is configured to notify the cloud data transfer service 230 of the transfer event. The cloud data transfer service 230 may initiate the data transfer in response to the notification from the serverless listener 220. In some instances, this may involve initiating a pre-configured routine at the cloud data transfer service 230 so that the cloud data transfer service 230 is prompted to check the event queue 212 and obtain any object information that needs to be transferred in the transfer event.

The cloud data transfer service 230 is further configured to forward the transfer events stored in the event queue 212 to the workers 240 for execution. Each worker 240 may include one or more processing devices or groups of processing devices capable of executing jobs such as data transfer jobs. Each worker 240 may be represented by a separate node within the cloud platform 200, and may be referred to herein as worker nodes. Upon being prompted by the cloud data transfer service 230 to execute a data transfer, the worker nodes may begin executing the transfer immediately, without waiting for additional data to be added to the event queue 212 before executing the transfer. Data identified based on the information in the event queue 212—which may be an identification of the source location 202 or the data itself—may be divided among multiple worker nodes, which may operate on different respective portions of the source data in parallel. This allows for the worker nodes 240 to quickly and efficiently execute the transfer from the source location 202 to the destination location 204.

In some examples, data may be stored in buckets at both the source and destination locations 202, 204. In such an example, a change in the source bucket may prompt a transfer event, and the transfer request for the transfer event may identify the bucket at the source location 202 as well as the bucket at the destination location for facilitating the transfer. The source bucket and destination bucket may, in turn, be identified by the data transfer service 230 to the workers 240 for executing the transfer.

In the example of FIG. 2, the serverless listener 220 is set up to periodically check a message queuing service 215 for transfer requests. FIG. 3 illustrates a different implementation of a data transfer system 300 in which transfer requests 301 may be sent directly to the serverless listener 320, without requiring a message queuing service. In the example of FIG. 3, the transfer request 301 may be sent to an address of the serverless listener. In this regard, the serverless listener may be a server, such as an HTTP server, that is exposed to the internet such that any transfer request automatically wakes up the serverless listener and prompts the serverless listener to store the transfer request in memory 310. In the example of FIG. 3, the memory used for storing the transfer request 301 may be application storage layer memory of the cloud data transfer service 330. Once the transfer request, including the source and destination locations 302, 304 or other identifying information, is stored within the memory 310, the cloud data transfer service 330 may instruct the one or more workers 340 to execute the transfer in the same or similar manner as described in connection with FIG. 2.

In the examples of FIGS. 2 and 3, the source and destination locations are shown separately from the data transfer system 200 for sake of clarity. In some examples, the source and destination locations may be located separately from the data transfer system 200. However, in other examples, at least one of the source and destination locations may be colocated with the data transfer system 200. Furthermore, the source and destination locations may be located in separate cloud platforms or in the same cloud platform, in separate geographic regions or in the same geographic regions, associated with different projects or workloads, or associated with the same project or workload, and so on.

### Example Methods

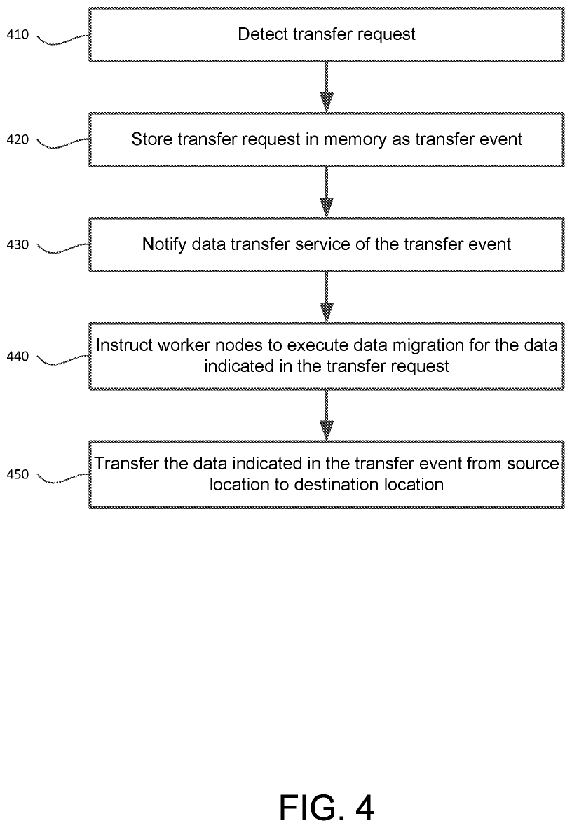

FIG. 4 is a block flow diagram illustrating an example routine 400 for transferring data using the example data transfer systems of the present disclosure. The operations performed in the example routine 400 may be carried out by the various components of the data transfer system, such as either system shown in FIGS. 2 and 3.

At block 410, a transfer request may be detected by a serverless listener. The serverless listener may be located remotely from the source of the transfer request. In some examples, the serverless listener may be configured to continuously listen for requests, whereby incoming requests that are addressed to the serverless listener are automatically handled upon receipt. In other examples, the serverless listener may be configured to periodically check a separate message queueing service for received transfer requests, and upon checking the message queueing service and finding a transfer request immediately handling the request upon discovery. In the case of periodic listening, the period may be set on the order of minutes, such as about one minute, about three minutes, about five minutes, about ten minutes, and so on. The frequency at which the periodic listening can occur may be considered frequent enough for the system to be considered an “on-demand” system that handles transfer requests as they arrive instead of batching requests and handling only approximately every hour.

At block 420, the transfer request may be stored in memory. Storing the transfer request in memory may include either one or both of initially storing the transfer request in an event queue for detection by the serverless listener and storing the transfer request in application layer memory of the data transfer service. In either case, the stored transfer request may be interpreted by the data transfer system as an individual transfer event.

At block 430, the serverless listener may notify the data transfer service of the transfer request. Notifying the data transfer service may cause the data transfer service to wake up on an on-demand basis, as opposed to having data transfers occur at predetermined intervals.

At block 440, the data transfer service may instruct one or more worker nodes included in the data transfer system to execute data migration for the data indicated in the transfer event. Instructing the worker nodes may include forwarding the transfer event from the memory to the worker nodes for handling. At block 450, the worker nodes may operate in parallel to transfer the data indicated in the transfer event from its source location to a destination location.

In the example routine 400 of FIG. 4, all transfer events included in the event queue are forwarded to the data transfer service on a per-event basis by the serverless listener. However, in other example routines, the serverless listener may be configured to selectively pass some transfer events to the data transfer service on a per-event basis, while other transfer events are held for batch processing until a later time, such as a regularly or periodically scheduled time. In such examples, the serverless listener may be configured to analyze the contents of the transfer request in order to determine a type of transfer event that is stored in the memory. For instance, the transfer event may be treated on a per-event basis in response to the transfer event being an object-level event, whereas larger events that are at scales larger than object-level may be held in the memory for batch migration. Filtering the non-object-level transfer events from the object-level events may ensure that the data transfer service can operate efficiently on small requests on an on-demand basis by avoiding consuming bandwidth over larger events at the same time. Instead, the larger events are held for batch processing.

The above examples generally describe transfer of data from one source location to another destination location. It should be understood that transferring data does not necessarily require the data to be erased or otherwise changed in the source location. In fact, a transfer of data may involve replication of data between the source and destination locations. Furthermore, to the extent that replicas of the same data exist in both source and destination locations, changes to the data in one location may prompt the changes to be transferred to the other location to maintain synchronicity between the replicas. In such a case, a change to the data at the source location may itself initiate a transfer request, whereby the location of the change is the source location and the location of the corresponding replicated data is the destination location. Replicated data may be useful for several purposes, including but not limited to creating backups of data, for performing disaster recovery operations based on previously created backups, for performing analytics on the data, for performing live migration of data, or for efficiently sharing data access among multiple geographical locations such as different continents or different areas that are not covered by dual-region and multi-region storage services.

The above examples also generally describe transfer of data from one source location to one destination location. However, it should be recognized that the same or similar principles can be applied to transfer data between multiple source and multiple destination locations. In some examples, each source location or each destination location may be treated as a separate transfer event. In other examples, a single transfer event may identify multiple locations, whereby execution of the transfer may be divided among multiple worker nodes to efficiently move the data from the multiple source locations, to the multiple destination locations, or both.

The above example systems and routines generally provide several advantages over current data transfer services that operate periodically. For example, the systems and methods of the present disclosure can operate at a per-event basis, meaning that single events received at the system can be handled by the system's resources without having to compete with other events for the same resources. For further example, the systems and methods can operate at an on-demand basis, meaning lower wait times for data migration.

The above example systems and methods are further capable of transferring data between cloud platforms within a shortened timeframe. This means that data stored in one cloud platform can be timely processed or analyzed in another cloud platform. Data backups can also be created quickly, meaning lower downtime during backup operations. Furthermore, by leveraging the data processing service's ability to coordinate several worker nodes in parallel, any number of copies of the data may be created and transferred without significantly affecting data availability at the source location, and without significantly lowering data throughput and latency at the data transfer system or across the network.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A data transfer system comprising:
one or more processors; and
memory having programmed thereon instruction for causing the one or more processors to:
detect a transfer request transmitted from a location remote from the data transfer system, wherein the transfer request specifies one or more data objects, a source location of the one or more data objects, and a destination location to which the one or more data objects are to be transferred;
in response to detection of the transfer request:
create a transfer event for the one or more data objects; and
notify a data transfer service included in the data transfer system of the transfer event, wherein the data transfer service is configured to control one or more worker nodes for migration of data, whereby execution of the transfer event causes the one or more worker nodes to move the one or more data objects specified in the transfer event from the source location to the destination location.

2. The system of claim 1, wherein each of the source location and the destination location are located in different cloud platforms.

3. The system of claim 1, wherein the memory further comprises a queue configured to store the transfer request, and wherein each transfer request stored in the queue corresponds to a separate transfer event.

4. The system of claim 3, wherein the one or more processors are configured to detect the transfer request stored in the queue using a serverless listener.

5. The system of claim 4, wherein the queue is managed by a message queuing service, and wherein the serverless listener is configured to periodically check the message queuing service for new transfer requests on an order of minutes or faster.

6. The system of claim 5, wherein the serverless listener is configured to:
identify the new transfer requests based on a message in the message queuing service requesting to initiate copying of a data object from a preconfigured transferred job associated with data transfer service.

7. The system of claim 1, wherein the memory further comprises an application storage layer memory of the data transfer service configured to store the transfer event.

8. The system of claim 7, wherein the one or more processors are configured to direct the transfer request to the memory using a serverless listener, wherein the transfer request is directed to the memory in response to the transfer request being sent to an address of the serverless listener.

9. The system of claim 1, further comprising the data transfer service, wherein the data transfer service is configured to:
receive the transfer event from the memory;
in response to the notification received from the one or more processors, select at least one of the one or more worker nodes for execution of the transfer event; and
forward the transfer event to the selected worker nodes for execution.

10. The system of claim 9, wherein the data transfer service is configured to:
determine whether the transfer event is an object-level transfer event;
in response to the transfer event being an object-level transfer event, forward the transfer event to the selected worker nodes for execution; and
in response to the transfer event not being an object-level transfer event, holding the transfer event for batch migration.

11. The system of claim 1, further comprising the one or more worker nodes.

12. The system of claim 9, wherein the transfer request is a request to replicate the one or more data objects in a plurality of destination locations, and wherein the data transfer service is configured to assign the transfer event to a plurality of worker nodes, wherein each worker node is assigned to copy the one or more data objects to a respective one of the plurality of destination locations.

13. A data transfer method comprising:
detecting, by one or more processors, a transfer request specifying one or more data objects, a source location of the one or more data objects, and a destination location to which the one or more data objects are to be transferred;
creating, by the one or more processors, a transfer event for the one or more data objects;
notifying, by the one or more processors, a data transfer service included in the data transfer system of the transfer event;
controlling, by the data transfer service, one or more worker nodes for execution of the transfer event, whereby execution of the transfer event causes the one or more worker nodes to move the one or more data objects specified in the transfer request from the source location to the destination location.

14. The method of claim 13, wherein each of the source location and the destination location are located in different cloud platforms.

15. The method of claim 13, wherein detecting the transfer request comprises periodically checking, by the one or more processors, a message queuing service for new transfer requests on an order of minutes or faster.

16. The method of claim 15, further comprising identifying, by the one or more processors, the new transfer requests based on a message in the message queuing service requesting to initiate copying of a data object from a preconfigured transferred job associated with the data transfer service.

17. The method of claim 13, further comprising:
storing, by the one or more processors, the transfer event in an application storage layer memory of the data transfer service, wherein the storing is performed by a serverless listener in response to the transfer request being sent to an address of the serverless listener.

18. The method of claim 13, further comprising, in response to the received notification:
selecting, by the data transfer service, one or more worker nodes for execution of the transfer event; and
forwarding, by the data transfer service, the transfer event to the one or more selected worker nodes for execution.

19. The method of claim 18, further comprising:
determining, by the one or more processors, whether the transfer event is an object-level transfer event;
in response to the transfer event being an object-level transfer event, forwarding, by the data transfer service, the transfer event to the selected worker nodes for execution.

20. The method of claim 13, wherein the transfer request is a request to replicate the one or more data objects in a plurality of destination locations, and wherein the method comprises assigning, by the data transfer service, the transfer request to a plurality of worker nodes, wherein each worker node is assigned to copy the one or more data objects to a respective one of the plurality of destination locations.
